(19) United States
(12) Patent Application Publication
(10) Pub. No.: US 2011/0282916 A1
(43) Pub. Date: Nov. 17, 2011

(54) Methods and Systems for Duplicate Document Management in a Document Review System

(76) Inventors: Judy Torres, El Paso, TX (US); Willem R. Van Den Berge, El Paso, TX (US); Howard Hart, El Paso, TX (US)

(21) Appl. No.: 12/778,918

(22) Filed: May 12, 2010

(51) Int. Cl. G06F 17/30

(52) U.S. Cl. 707/803; 707/E17.009

(57) ABSTRACT

Methods and systems are disclosed for duplicate document management in a document review system. In one embodiment, the method may include receiving tag configuration information for a tag in a document review system. The method may further include applying the tag configuration information to define a configured tag. The method may further include determining, with a processing device, the applicability of the configured tag to one or more documents. The method may further include applying the configured tag to one or more documents in response to the determination.

### CROSS-REFERENCE TO RELATED APPLICATIONS

The entire disclosure of commonly-assigned, co-pending application Ser. No. 12/038,791 with Publication number US 2008/0222168 entitled “Method and System for Hierarchical Document Management in a Document Review System” by inventor David Morales, is incorporated herein by reference.

The entire disclosure of commonly-assigned, co-pending application Ser. No. 12/038,799 with Publication number US 2008/0222112 entitled “Method and System for Document Searching and Generating To Do List” by inventor David Morales, is incorporated herein by reference.

The entire disclosure of commonly-assigned, co-pending application Ser. No. 12/038,797 with Publication number US 2008/0222141 entitled “Method and System for Document Searching” by inventor David Morales, is incorporated herein by reference.

The entire disclosure of commonly-assigned, co-pending application Ser. No. 12/038,795 with Publication number US 2008/0222513 entitled “Method and System for Rules-Based Tag Management in a Document Review System” by inventor Willem Van Den Berge, is incorporated herein by reference.

The entire disclosure of commonly-assigned, co-pending application Ser. No. 12/038,802 with Publication number US 2008/0218808 entitled “Method and System for Universal File Types in a Document Review System” by inventor Willem Van Den Berge, is incorporated herein by reference.

### BACKGROUND

1. Field of the Invention

This invention relates generally to the field of document review systems. More particularly, and without limitation, the invention relates to methods and systems for duplicate document management in a document review system.

2. Description of the Related Art

Document review systems may be used for managing document review in the discovery phase of litigation. Document review systems may manage millions of documents as part of one matter in litigation. A document review system may be used to identify which documents are privileged and which documents are not privileged. For example, a tag may be applied to a document classifying the document as privileged, and similarly, a tag may be applied to a document classifying the document as not privileged.

Within the millions of documents that may be within the document review system for one matter in litigation, duplicate documents may exist. For example, multiple copies of the same document may be included in the document populations collected for one or more custodians. The existence of duplicate documents may create inefficiency and unwanted redundancy in a document review system. Additionally, the presence of duplicate documents that are unidentified as such may create the possibility of inconsistent tag applications. For example, one instance of the document could be tagged as privileged and a second instance of the document could be tagged as not privileged.

### SUMMARY OF THE INVENTION

Methods are claimed for duplicate document management in a document review system. Certain embodiments of the method may include receiving tag configuration information for a tag in a document review system. The method may further include applying the tag configuration information to define a configured tag. The method may also include determining, with a processing device, the applicability of the configured tag to one or more documents. The method may include applying the configured tag to one or more documents in response to the determination.

In certain embodiments, determining the applicability of the configured tag to one or more documents in the document review system may include assigning a document identifier to one or more documents. Determining the applicability of the configured tag may further include assigning a document hash to one or more documents. Determining the applicability of the configured tag may further include storing the document identifier and the document hash for one or more documents. Determining the applicability of the configured tag may further include retrieving one or more documents in response to the document identifier of one or more documents.

In certain embodiments, assigning the document hash may include a hash calculation. In certain embodiments, the method may include identifying the size of one or more documents before determining the document hash.

In certain embodiments, the method may further include applying the configured tag to one or more documents in response to adding one or more documents to the document review system.

In certain embodiments, the method may further include applying an updated configured tag to one or more documents in response to receiving an updated tag configuration for the configured tag.

In certain embodiments, the method may further include removing the configured tag from one or more documents in response to receiving an updated tag configuration for the configured tag.

In certain embodiments, the method may further include removing the configured tag from one or more documents in response to removing the configured tag from one or more documents.

In certain embodiments of the method, receiving tag configuration information for the tag may include receiving electronic mail message setup options. Certain embodiments of the method may further include identifying electronic mail message documents.

A computer program product for duplicate document management is also enclosed. The computer program product tangibly embodies computer readable instructions that, when executed by a computer, may cause the computer to perform operations. In certain embodiments, the operations may include receiving tag configuration information for a tag in a document review system. In certain embodiments, the operations may further include applying the tag configuration information to define a configured tag. In certain embodiments, the operations may further include determining the applicability of the configured tag to one or more documents. In certain embodiments, the operations may further include applying the configured tag to one or more documents in response to the determination.

In certain embodiments, the operation of determining the applicability of the tag to one or more documents in the document review system may include assigning a document identifier to one or more documents. In certain embodiments, the operation may include assigning a document hash to one or more documents. In certain embodiments, the operation may further include storing the document identifier and the document hash for one or more documents. In certain embodiments, the operation may further include retrieving one or more documents in response to the document identifier of one or more documents.

In certain embodiments, the operation of assigning the document hash may include a hash calculation. In certain embodiments, the operations may further include identifying the size of one or more documents before determining the document hash.

In certain embodiments, the operations may include applying the configured tag to one or more documents in response to adding one or more documents to the document review system.

In certain embodiments, the operations may include applying an updated configured tag to one or more documents in response to receiving an updated tag configuration for the configured tag.

In certain embodiments, the operations may include removing the configured tag from one or more documents in response to receiving an updated tag configuration for the configured tag.

In certain embodiments, the operations may include removing the configured tag from one or more documents in response to removing the configured tag from one or more documents.

In certain embodiments, the operation of receiving tag configuration information for the tag may include receiving electronic mail message setup options. In certain embodiments, the operations may include identifying electronic mail message documents.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic flow chart diagram illustrating one embodiment of a method for managing duplicates in a document review system.

FIG. 2 is a schematic flow chart diagram illustrating one embodiment of method for determining the applicability of a tag to one or more documents.

FIG. 3 is one embodiment of a computer program product that may be used in accordance with certain embodiments of the disclosed methods.

FIG. 4 is one embodiment of a graphical user interface used to receive tag configuration information.

FIG. 5 is one embodiment of a graphical user interface used to receive electronic mail setup options.

FIG. 6 is one embodiment of a graphical user interface console.

### DETAILED DESCRIPTION

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

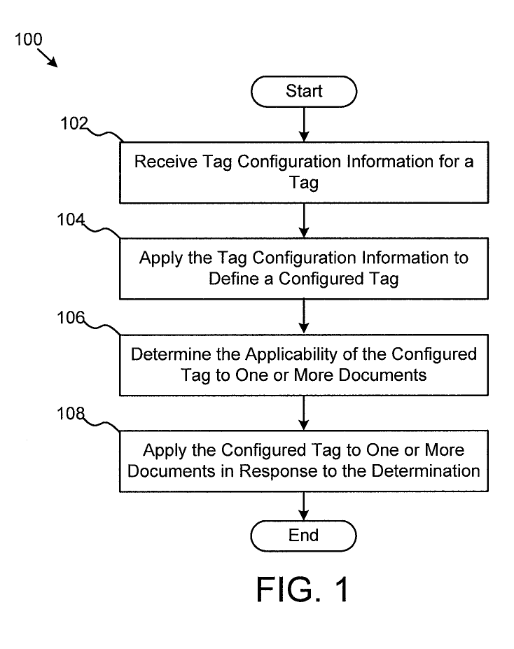

FIG. 1 illustrates one embodiment of a method 100 for duplicate document management in a document review system. The method 100 may include receiving 102 tag configuration information for a tag in a document review system. A tag is generally an identifier that may be used to indicate some predefined characteristic associated with a particular document. For example, a tag may indicate that a particular document in the document review system is privileged. Other tags may reflect that a particular document may be relevant, confidential, or ready-to-be produced. Tags as may used in a document review system are discussed in more detail in United State Patent Publication US 2008/0222513, incorporated herein by reference. The tag configuration information received 102 may indicate that this tag will be used for duplicate document management. The tag configuration information may be received 102 from a user input or a database.

The method 100 may also include applying 104 the tag configuration information to the tag to define a configured tag. A configured tag may used in duplicate document management. In certain embodiments of method 100, configured tags may be displayed differently from non-configured tags. For example, in one embodiment, configured tags are orange and non-configured tags are blue.

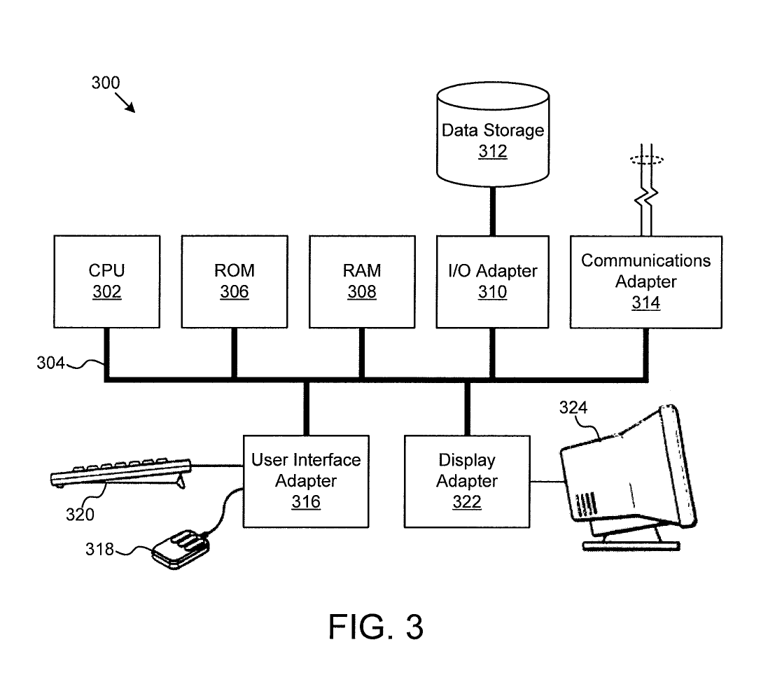

The method 100 may also include determining 106, with a processing device, the applicability of the configured tag to one or more documents. Embodiments of a processing device are described in more detail below with reference to FIG. 3. Determining 106 the applicability of the configured tag to one or more documents may include determining the plurality of documents in the document review system that are identical or nearly identical. In some embodiments, determining 106 the applicability of the configured tag to one or more documents may include comparing the documents in a document review system to determine if the documents are identical or nearly identical.

In certain embodiments, determining 106 the applicability of the configured tag to one or more documents may be performed in response to applying the configured tag to a document to create a tagged document. For example, a configured tag indicating that a document is privileged may be applied to a document to create a tagged document. Applying a configured tag to the document associates the configured tag with the document and may also indicate that this tagged document will be used in duplicate document management. The method 100 may then determine 106 whether the configured tag may also apply to a plurality of other documents in the document review system. The configured tag may be applicable to documents that are identical or nearly identical to the tagged document.

In certain embodiments, determining 106 the applicability of the configured tag to one or more documents may be performed in response to applying the configured tag to several documents to create several tagged documents. For example, a configured tag indicating that a document is privileged may be applied to a family of documents to create a family of tagged documents. Applying a configured tag to the family of documents may associate each of the documents in the family to the configured tag and may also indicate that each of these tagged documents may be used in duplicate document management. The method 100 may then determine whether the configured tag may also apply to a plurality of other documents in the document review system. The configured tag may be applicable to documents that are identical or nearly identical to the tagged documents.

In certain embodiments, determining 106 the applicability of the configured tag to one or more documents may be performed in response to selecting a document or group of documents to be tagged. For example, a document may be selected to be tagged, and the method 100 may then determine whether the configured tag may apply to a plurality of other documents in the document review system that are identical or nearly identical to the selected document.

The method 100 may also include applying 108 the configured tag to one or more documents in response to the determination 106 of whether one or more documents are applicable. In certain embodiments, the configured tag is applied 108 to the one or more documents determined 106 to be identical or nearly identical to the tagged documents or selected documents. In some embodiments, the method 100 automatically applies 108 the configure tag to one or more documents in response to the determination.

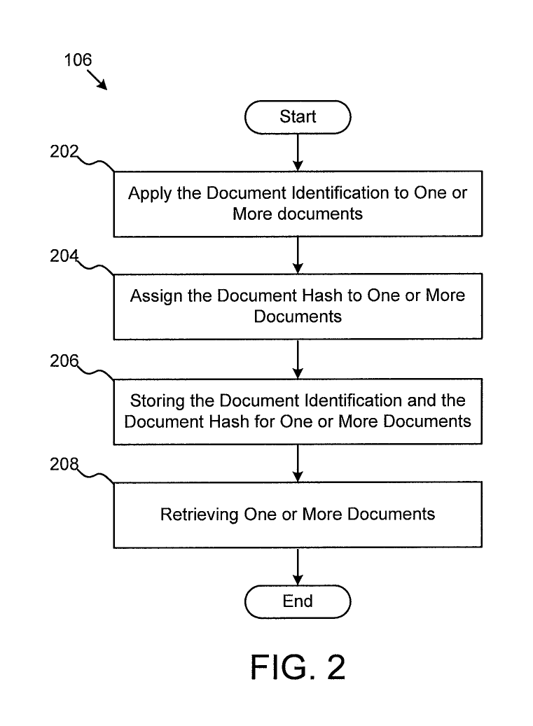

FIG. 2 illustrates one embodiment for determining 106 the applicability of the configured tag to one or more documents. In certain embodiments, determining 106 the applicability of the tag to one or more documents may include assigning 202 a document identifier to one or more documents. In some embodiments, each document in a document review system may be assigned 202 a document identifier. In certain embodiments, the document identifier may be a unique document identifier for each document in the document review system. For example, a document review system with 1,000,001 documents may have 1,000,001 unique document identifiers. In some embodiments, documents may be assigned a document identifier whenever a document is added to the document review system. In other embodiments, one or more documents may be assigned a document identifier at a later time. The document identifiers may allow the document review system to keep track of each of the individual documents in the system.

In certain embodiments, determining 106 the applicability of the tag to one or more documents may also include assigning 204 a document hash to one or more documents in the document review system. In some embodiments, each document in the document review system may be assigned 204 a document hash. In certain embodiments, the document hash may uniquely identify the content of a document. For example, two identical—or nearly identical—documents in a document review system may have the same document hash, but may also have different document identifiers. Assigning 204 a document hash that uniquely identifies the content of a document may allow method 100 to compare documents to determine if they are identical or nearly identical.

In certain embodiments, evaluation of a document's hash may reveal that it is not a duplicate of other documents in the document review system, even though the documents appear to be the same. In other embodiments, evaluation of a document's hash may reveal that it is a duplicate of other documents in the document review system, even though the documents appear to be different.

In certain embodiments, assigning 204 a document hash to one or more documents includes a hash calculation. A variety of hash calculations are well-known in the art. A hash calculation converts a large amount of data into a small amount of data. In certain embodiments, a document may be input into a hash calculator and a document hash may be output from the hash calculator. The resulting document hash may be assigned 204 to the document. Certain embodiments of method 100 may use a secure hash algorithm (SHA). The SHA algorithm may include the variants SHA-0, SHA-1, or SHA-2. The SHA-2 algorithm may include variants SHA-224, SHA-256, SHA-384, or the SHA-512 variants. A SHA-256 hash calculation may convert a variable sized document into a 256-bit (or 32-byte) hash code.

In certain embodiments, the entire document may be input to the hash calculation in binary form. In other embodiments, the size of the document may be determined before assigning a document hash. In certain embodiments, the entire document may be input to the hash calculation in binary form only if the size of the document is determined to be less than or equal to 10 MB. For documents determined to be greater than 10 MB, only the 5 MB and the last 5 MB may be input to the hash calculator in binary format.

In certain embodiments, determining 106 the applicability of the tag to one or more documents may also include storing 206 the document identifier and document hash for one or more documents. In certain embodiments, the document hash and document identifier may be stored in a cache or a database. For example, a structured query language (SQL) database may be used. In some embodiments, the document hash and document identifier may stored in computer memory. One of ordinary skill in the art will be able to determine a variety of storage options for quickly storing and quickly retrieving document identifiers and document hashes.

In certain embodiments, determining 106 the applicability of the tag to one or more documents may also include retrieving 208 one or more documents in response to the document identifier of one or more documents. In some embodiments, given the document identifier for a document, the method 100 may first retrieve an associated document for the document identifier, and subsequently retrieve the associated document hash. In other embodiments, given the document identifier for a document, the method 100 may only retrieve the associated document hash. One or more documents may then be retrieved from storage that share the same document hash within the document storage system. As described earlier, a configured tag may then be applied to the one or more retrieved documents.

In certain embodiments, the method 100 may further include applying the configured tag to one or more documents in response to adding one or more documents to the document review system. In certain embodiments, when one or more new documents are added to the document review system, the method 100 may determine 106 the applicability of all applied configured tags to the one or more new documents. For example, a document may be added to the document review system after several other documents have been reviewed and tagged. If this newly added document is identical or nearly identical to a document with a configured tag, the configured tag may be automatically applied by method 100 to the newly added document.

In certain embodiments, the method 100 may further include applying an updated configured tag to one or more documents in response to receiving an updated tag configuration for the configured tag. In certain embodiments, a tag configuration of a tag may be updated after a tag has already been applied to a document. If the tag configuration of a tag is updated to form an updated configured tag, the method 100 may determine the applicability of the updated configured tag to one or more documents and may apply the updated configured tag to one or more documents. For example, several documents in a document review system may be associated with a non-configured privilege tag. These privilege tags may be subsequently updated to form updated configured tags. For each document newly marked with an updated configured tag, the method 100 may determine the applicability of the updated configured tag to the other documents in the document review system and may apply the updated configured tag the applicable documents.

In certain embodiments, the method 100 may further include removing the configured tag from one or more documents in response to receiving an updated tag configuration for the configured tag. In certain embodiments, a tag configuration of the configured tag may be updated after a tag has already been applied to a document. An updated tag configuration for a configured tag may include removing the duplicate document management functionality. In certain embodiments, if the duplicate document management functionality is removed from a configured tag, the configured tag may also be removed from one or more documents. For example, document A may be originally tagged with a configured tag, and as a result, method 100 applies the configured tag to identical documents B and C. If the configured tag associated with document A is updated to remove the duplicate document functionality, the configured tags of documents B and C may be removed.

In certain embodiments, the method 100 may further remove the configured tag from one or more documents in response to removing the configured tag from one or more documents. In certain embodiments, the configured tag associated with a document may be removed after a tag has already been applied to the document. If the configured tag is removed from a document, configured tags may also be removed from one or more documents. For example, document A may be originally tagged with a configured tag, and as a result, method 100 applies the configured tag to identical documents B and C. If the configured tag associated with document A is removed, the configured tags of documents B and C may be removed.

In certain embodiments of method 100, receiving 102 tag configuration information for the tag further comprises receiving electronic mail message setup options. In certain embodiments, the duplicate document management of electronic mail messages may be different from the duplicate document management of other documents. In determining whether two regular documents are identical, the documents may be compared directly. As explained earlier, in certain embodiments, two documents with the same document hash may be identical. Electronic mail messages may be more difficult to compare. Two of the same electronic mail messages may have different electronic mail message headers. For example, if person A sends an electronic mail message to person B and C, these electronic mail messages received by B and C should be detected as identical. However, an electronic mail message server may insert information into the electronic mail message header, such as metadata. When compared, these two electronic mail message may appear to not be identical.

In certain embodiments, the method 100 may further include identifying whether a document is an electronic mail message. In certain embodiments, determining 106 the applicability of a configured tag to one or more electronic mail messages may be different from determining 106 the applicability of a configured tag to a non-electronic mail message. In certain embodiments, the eCapture software product from IPRO identifies whether a document is an electronic mail message.

In certain embodiments, an electronic mail message may be assigned 204 a document hash in a different way than a non-electronic mail message. In certain embodiments, the tag configuration information includes a plurality of setup options used to determine which parts of an electronic mail message may be used in duplicate document management. In certain embodiments, rather than use the entire binary form of the electronic mail message in the hash calculation, only certain selected parts of the e-mail may be used. In certain embodiments, these parameters include without limitation: Use Subject, Use From Address, Use To Address, Use CC Address, Use BBC Address, Use Attachment Count, Use Attachment Names, Use Date Sent, Use Create Date, Use Last Modified Date, and Use Body. In certain embodiments, if the Use Subject Parameter is received 102 in the tag configuration information, the hash calculation for an electronic mail message may use the binary content of the electronic mail message subject. In certain embodiments, if the Use From Address parameter is received 102 in the tag configuration information, the hash calculation for an electronic mail message may use the binary content of the electronic mail message From address. In certain embodiments, if the Use To Address Parameter is received 102 in the tag configuration information, the hash calculation for an electronic mail message may use the binary content of the electronic mail message recipient addresses. In certain embodiments, if the Use CC Parameter is received 102 in the tag configuration information, the hash calculation for an electronic mail message may use the binary content of the electronic mail message carbon copy recipient addresses. In certain embodiments, if the Blind Carbon Copy Parameter is received 102 in the tag configuration information, the hash calculation for an electronic mail message may use the binary content of the electronic mail message blind carbon copy recipient addresses. In certain embodiments, if the Use Attachment Count Parameter is received 102 in the tag configuration information, the hash calculation for an electronic mail message may use the number of attachments. In certain embodiments, if the Use Attachment Names Parameter is received 102 in the tag configuration information, the hash calculation for an electronic mail message may use the binary content of the names of the files that are attachments to the electronic mail message. In certain embodiments, if the Use Date Sent Parameter is received 102 in the tag configuration information, the hash calculation for an electronic mail message may use the binary content of the date sent of the electronic mail message. In certain embodiments, if the Use Create Date Parameter is received 102 in the tag configuration information, the hash calculation for an electronic mail message may use the binary content of the electronic mail message subject was created. In certain embodiments, if the electronic mail message does not have an identifiable sent date, the date the electronic mail message was created may be used in lieu of the sent date. In certain embodiments, if the Use Last Modified Date Parameter is received 102 in the tag configuration information, the hash calculation for an electronic mail message may use the binary content of the electronic mail message was last modified. In certain embodiments, if the electronic mail message does not have an identifiable sent date, the date the electronic mail message was last modified may be used in lieu of the sent date. In certain embodiments, all of the dates are normalized to Greenwich Mean Team (GMT). In certain embodiments, if the Use Body Date Parameter is received 102 in the tag configuration information, the hash calculation for an electronic mail message may use the binary content of the electronic mail message body text.

In certain embodiments, an input string to be used as an input to the hash calculator may be used. In certain embodiments, the input string is created by processing the parts of the electronic mail message as selected by the tag configuration information. For example, if the Use Body and the Use Subject Parameters are selected, the body and the subject o the electronic mail message may processed before the hash calculation. In certain embodiments, the indicated parts of the electronic mail message may be processed by removing all punctuation and white space. In certain embodiments, character of the indicated parts of the electronic mail message are converted to upper case representations. In certain embodiments, the indicated parts of the electronic mail message are appended together to form a single input string. In certain embodiments, a pipe bar delimiter (“|”) may be inserted between the individual indicated parts of the electronic mail message. In certain embodiments, the input string is used as the input to the hash calculation to assign a 204 a document hash.

A computer program product may perform the steps of method 100. Moreover, the computer program product may include a stand-alone box, a compact disc, a DVD, a flash storage drive, an optical storage drive, or a like device. The computer program product may be run on a stand-alone computer systems 300 such as a personal computer, PDA, server, or workstation. The discussion below presents certain embodiments of a computer system 300.

FIG. 3 illustrates a computer system 300 for duplicate document management. The central processing unit (CPU) 302 is coupled to the system bus 304. The CPU 302 may be a general purpose CPU or microprocessor. The present embodiments are not restricted by the architecture of the CPU 302, so long as the CPU 302 supports the operations as described herein. The CPU 302 may execute the various logical instructions according to the present embodiments. For example, the CPU 302 may execute machine-level instructions according to the exemplary operations described with references to FIGS. 1 and 2.

The computer system 300 also may include Random Access Memory (RAM) 308, which may be SRAM, DRAM, SDRAM, or the like. The computer system 300 may utilize RAM 308 to store the various data structures—such as tag configuration information—used by a software application configured for duplicate document management. The computer system 300 may also include Read Only Memory (ROM) 906 which may be PROM, EPROM, EEPROM, optical storage, or the like. The ROM may store configuration information for booting the computer system 300.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300. In a further embodiment, the display adapter 322 may display a graphical user interface associated with a software or web-based application. The graphical user interface may include a computer program with corresponding code in Java, C++, C#, C, .NET or other like programming languages.

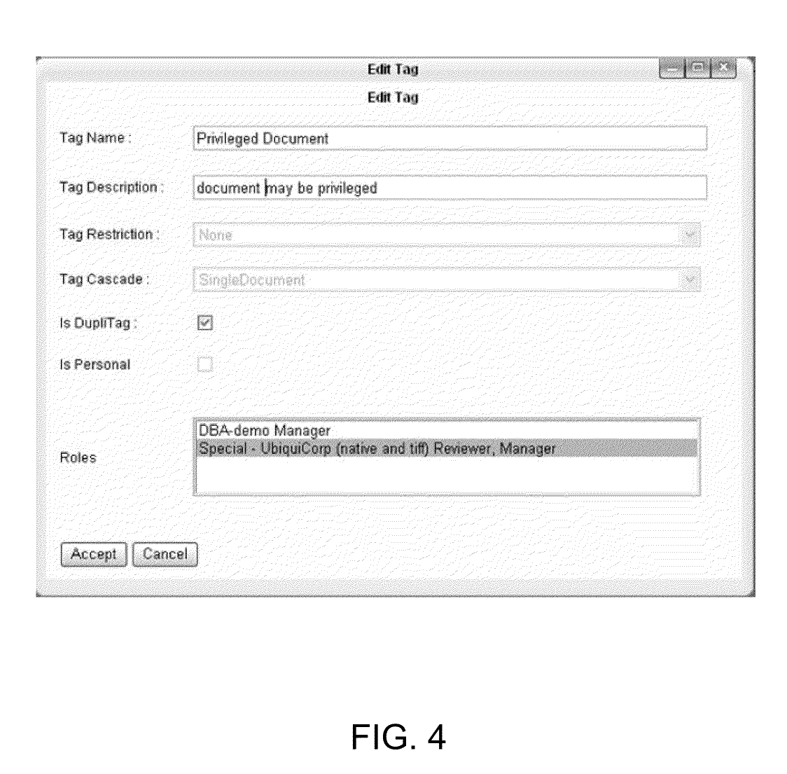

FIG. 4 illustrates one embodiment of part of a graphical user interface that may be used in conjunction with the computer program product. For example, FIG. 4 illustrates on embodiment of receiving tag configuration information for a tag in a document review system. In this embodiment, the user marks the “Is DupliTag” checkbox in the configuration of the “Privileged Document” tag to indicate that this tag should be used for duplicate document management.

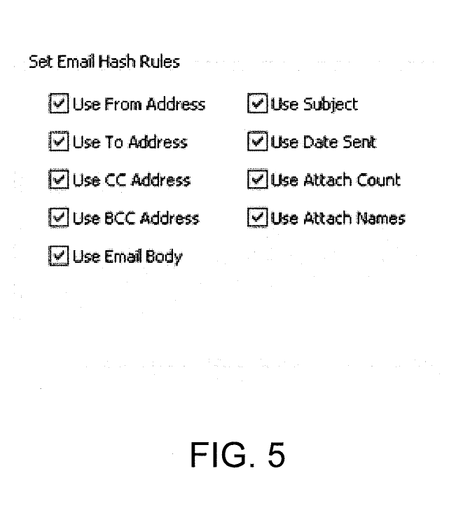

FIG. 5 illustrate one embodiment of another part of a graphical interface that may be used in conjunction with the computer program product. For example, FIG. 5 illustrates one embodiment of receiving electronic mail message setup options. In this embodiment, the user marks the check boxes associated with the relevant hash rules. Here, for example, the checked Use Subject box indicates that the hash calculation for an electronic mail message may use the binary content of the electronic mail message subject.

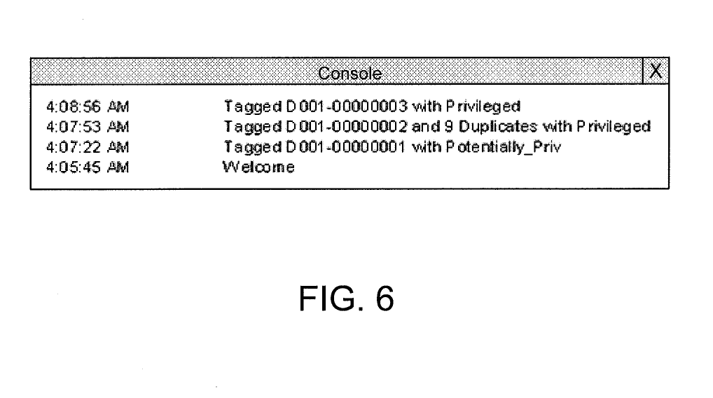

FIG. 6 illustrates one embodiment of another part of a graphical user interface that may be used in conjunction with the computer program product. For example, FIG. 6 illustrate one embodiment of a console that may be used to display recent activity within the document management system. In certain embodiments the console may optionally be removed or resized within the graphical user interface. As shown in FIG. 6, this embodiment of the console may reflect recent activity by the user with a time stamp and a description of the action. For example, this particular user began by logging on, as indicated by the “Welcome” description. Next, this particular user tagged a document as “Potentially_Priv.” Next, the user tagged a different document with “Privileged.” In this embodiment, the graphical user interface further indicates that 9 additional duplicate documents were tagged by the computer program product with the “Privileged” tag. In certain embodiments, the most recent activity in the console is in bold or highlighted. In certain embodiments, older activity may be faded. In certain embodiments, only the most recent activity is indicated in the console window.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 306, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted. For example, any suitable processor-based device may be utilized including without limitation, personal data assistants (PDAs), and multi-processor servers. Moreover, the present embodiments may be implemented on application-specific integrated circuits (ASIC) or very large scale integrated (VLSI) circuits. In fact, persons of ordinary skill in the art may utilize any number of suitable structures capable of executing logical operations according to the described embodiments.

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept should be apparent to those skilled in the art from this disclosure.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method, comprising:
receiving tag configuration information for a tag in a document review system;
applying the tag configuration information to define a configured tag;
determining, with a processing device, the applicability of the configured tag to one or more documents; and
applying the configured tag to one or more documents in response to the determination.

2. The method of claim 1, wherein determining the applicability of the configured tag to one or more documents in the document review system comprises:
assigning a document identifier to one or more documents;
assigning a document hash to one or more documents;
storing the document identifier and the document hash for one or more documents; and
retrieving one or more documents in response to the document identifier of one or more documents.

3. The method of claim 2, wherein assigning the document hash comprises a hash calculation.

4. The method of claim 2, further comprising identifying the size of one or more documents before determining the document hash.

5. The method of claim 1, further comprising applying the configured tag to one or more documents in response to adding one or more documents to the document review system.

6. The method of claim 1, further comprising applying an updated configured tag to one or more documents in response to receiving an updated tag configuration for the configured tag.

7. The method of claim 1, further comprising removing the configured tag from one or more documents in response to receiving an updated tag configuration for the configured tag.

8. The method of claim 1, further comprising removing the configured tag from one or more documents in response to removing the configured tag from one or more documents.

9. The method of claim 1, wherein receiving tag configuration information for the tag further comprises receiving electronic mail message setup options.

10. The method of claim 9, further comprising identifying electronic mail message documents.

11. A computer program product tangibly embodying computer readable instructions that, when executed by a computer, cause the computer to perform operations comprising:
receiving tag configuration information for a tag in a document review system;
applying the tag configuration information to define a configured tag;
determining the applicability of the configured tag to one or more documents; and
applying the configured tag to one or more documents in response to the determination.

12. The computer program product of claim 11, wherein determining the applicability of the configured tag to one or more documents in the document review system comprises:
assigning a document identifier to one or more documents;
assigning a document hash to one or more documents;
storing the document identifier and the document hash for one or more documents; and
retrieving one or more documents in response to the document identifier of one or more documents.

13. The computer program product of claim 12, wherein assigning the document hash comprises a hash calculation.

14. The computer program product of claim 12, the operations further comprising identifying the size of one or more documents before determining the document hash.

15. The computer program product of claim 11, the operations further comprising applying the configured tag to one or more documents in response to adding one or more documents to the document review system.

16. The computer program product of claim 11, the operations further comprising applying an updated configured tag to one or more documents in response to receiving an updated tag configuration for the configured tag.

17. The computer program product of claim 11, the operations further comprising removing the configured tag from one or more documents in response to receiving an updated tag configuration for the configured tag.

18. The computer program product of claim 17, the operations further comprising removing the configured tag from one or more documents in response to removing the configured tag from one or more documents.

19. The computer program product of claim 11, wherein receiving tag configuration information for the tag further comprises receiving electronic mail message setup options.

20. The computer program product of claim 19, the operations further comprising identifying electronic mail message documents.
